(19) United States
(12) Patent Application Publication
(10) Pub. No.: US 2026/0128911 A1
(43) Pub. Date: May 7, 2026

(54) SECURE PROVISIONING OF FIDO CREDENTIAL

(71) Applicant: ASSA ABLOY AB, Stockholm (SE)

(72) Inventors: François-Eric Michel Guyomarc'h, Clermont-l'Hérault (FR); Marc Raymond Powell, Paris (FR); Antonio Fidalgo, Courbevoie (FR)

(21) Appl. No.: 19/115,862

(22) PCT Filed: Oct. 10, 2022
(86) PCT No.: PCT/EP2022/078145

§ 371 Date: Mar. 27, 2025

(51) Int. Cl. H04L 9/32; H04L 9/30

(52) U.S. Cl. CPC H04L 9/3271; H04L 9/3073; H04L 9/3247

(57) ABSTRACT

A computing device implemented method of provisioning credential information includes activating a credentialing application stored in an authenticator device; receiving, by the credentialing application, user information entered into the authenticator device; establishing a secure channel between the authenticator device and an authentication server; sending the user information to the authentication server via the secure channel; generating a challenge by the authentication server in response to the user information and presenting the challenge to the user; sending a response to the challenge from the authenticator device to the authentication server via the secure channel; receiving a command from the authentication server to generate the credential information including a key pair; and registering a key of the key pair with the authentication server.

### TECHNICAL FIELD

Embodiments illustrated and described herein generally relate to automatic identity authentication systems that authenticate users for access to secure resources, and to techniques of secure messaging for identity authentication systems.

### BACKGROUND

There are many applications for which quick and accurate remote authentication of identity of a person is desirable. Some examples include access to online accounts for mobile banking and mobile shopping. Remote authentication often involves authentication information being exchanged between a user's mobile phone or other mobile device and a server performing authentication. Unfortunately, attempts to defeat systems that provide secure authentication occur often. It is desirable to develop authentication practices that are difficult to defeat.

### BRIEF DESCRIPTION OF THE DRAWINGS

FIG. 1 is a diagram of an example Fast Identification Online (FIDO) registration process.

FIG. 2 is a diagram of an example FIDO authentication process.

FIG. 3 is a diagram of another example of a FIDO registration process.

FIG. 4 is a flow diagram of an example of a method of provisioning a FIDO credential using a credentialing application of an authenticator device.

FIG. 5 is a block diagram schematic of portions of an example of an authenticator device.

### DETAILED DESCRIPTION

It is desirable for automatic authentication of a person's identity based on verifiable identity information to be fast and secure. Automatic device authentication involves exchanging sensitive information between devices to prove identity of the holder of a device, or to prove that information is originating from, or being provided to, an authorized device. For device-based authentication, a credential device presents sensitive credential information to prove identity or authorization to a resource, and a verifier device authenticates the credential information. A verifier device can be an authentication server (e.g., a cloud-based server) of the backend of an authentication system. A credential device can be a platform device (e.g., a desktop computer) or a mobile device (e.g., a mobile phone, laptop computer, tablet computer, smartwatch, etc.) of the user wishing to prove identity or authorization.

One approach to device-based authentication is to verify the device using passwords. However, passwords can be stolen or deduced by someone seeking unauthorized access to the secure resource. Fast Identification Online (FIDO) authentication is an open industry association that aims to reduce dependence on passwords for device-based authentication. For FIDO-based authentication, the credential device is an authenticator (e.g., a roaming authenticator or a platform authenticator). A user who wishes to enable FIDO-based authentication for an online service that supports FIDO needs to first register the user's authenticator device with that particular service.

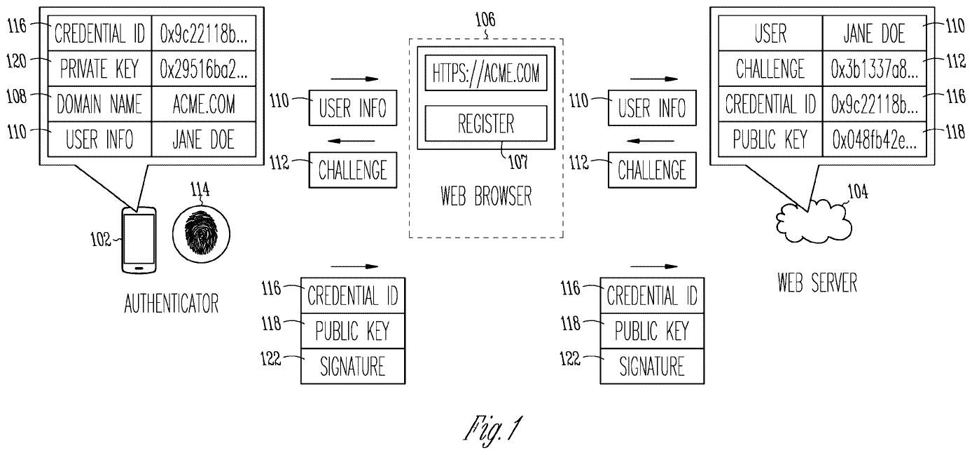

FIG. 1 is a diagram of an example FIDO registration process to register a FIDO authenticator 102. In the example, the authenticator 102 is a mobile phone. The registration is performed by a web server 104 of the online service that can be cloud-based and uses a support service provider (SSP) web browser 106 to provision credential devices. The web browser 106 implements the FIDO web authorization application program interface (WebAuthn API).

To register, the user enters the domain name 108 of the online service (e.g., acme. com) into the authenticator 102 to navigate the web browser 106 to the registration webpage 107 of the online service. Using the authenticator 102, the user signs into their account or creates a new account with user information 110 sent to the web server 104. The user may sign-in using a password. The web browser 106 prompts the user to register, e.g., by displaying a “Register” button that the user selects. The web server 104 generates a challenge 112 that is presented to the user. The challenge 112 is for previously configured information such as a personal identification number (PIN) or biometric 114. If the challenge 112 is passed, the WebAuthn API causes the web browser 106 to tell the authenticator 102 to generate a new credential (e.g., a credential identifier (ID) and a public/private key pair). The credential ID 116 and the public key 118 are returned to the server 104 via the browser 106 so that they can be registered with the online service. The private key 120 is retained by the authenticator 102 that can be used for generating a signature 122 by the authenticator 102. The webpage may show “Registration Complete” to indicate that the registration of the authenticator was successfully completed.

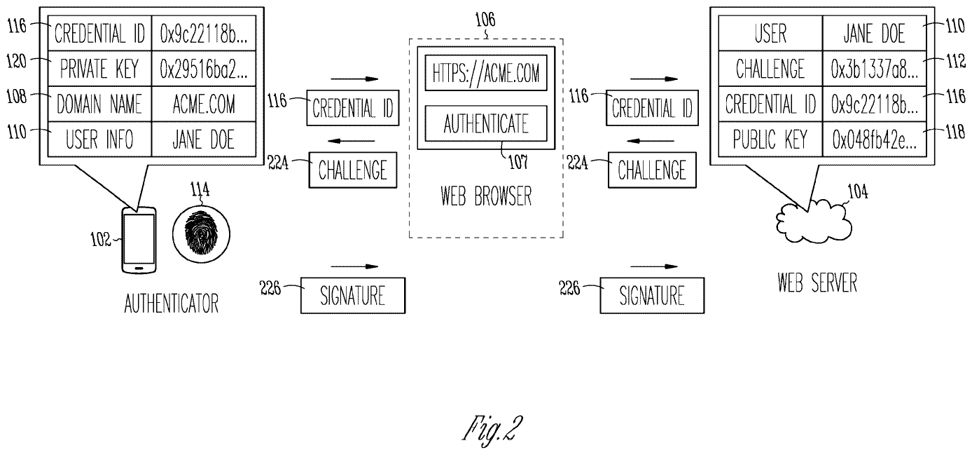

When the user wishes to authenticate to the server 104, the authenticator 102 proves possession of the private key 120 to the service by signing a challenge generated by the server 104. FIG. 2 is a diagram of an example FIDO authentication process. The user navigates to the webpage 107 in a web browser 106 using the authenticator 102 and initiates signing in by entering user information 110 and one or more of a password, PIN, or biometric 114. The authenticator 102 may send the Credential ID 116 to the server 104 at this time via the web browser 106. The server 104 generates a challenge 224 that the web browser 106 sends to the authenticator 102 or to a different device for two-device authentication (e.g., the user's personal computer, or PC). The authenticator 102 uses the private key 120 to generate an authentication signature 226 for a response returned to the web browser 106 and server 104. The server 104 verifies the response to the challenge 224 and uses the public key 118 to verify the authentication signature 226 of the response. The web browser 106 indicates that the user is signed in and navigates the authenticator 102 to a signed-in webpage.

The provisioning of authenticator devices in FIGS. 1 and 2 assumes that the web browser 106 is trusted and is not subject to an attack. The security of the provisioning relies on the capability of the web browser to protect against attacks such as Cross Site Request Forgery (CSRF) attacks, Man in the Middle attacks, Man in the Browser attacks, etc. In particular, the provisioning relies fully on the capability of the web browser 106 to securely identify the relying party origin. This assumption about the web browser 106 creates a single point of security failure for the FIDO credential provisioning. If a hacker is able to hack the origin or hack the communication with the authenticator device, the hacker may be able to issue a credential on the hacker's behalf or for a different origin than what was intended.

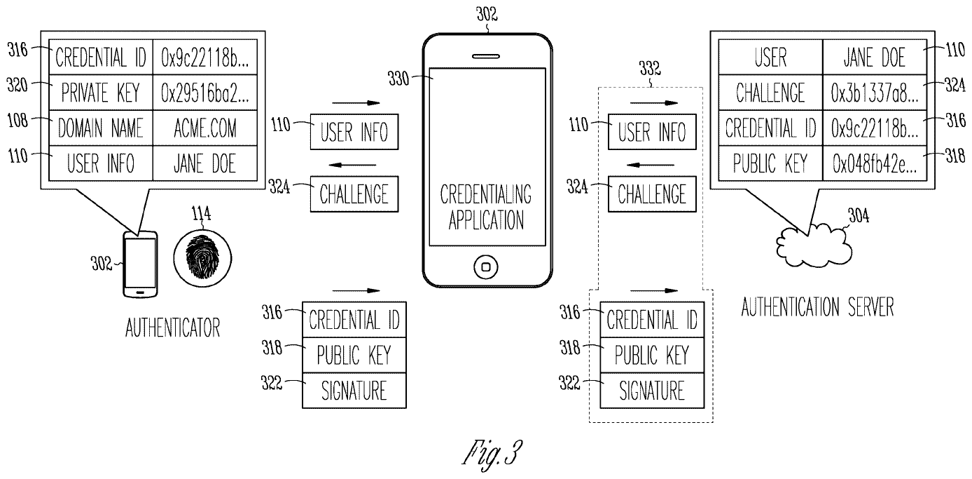

FIG. 3 is a diagram of an example FIDO registration process to register a FIDO authenticator that eliminates the web browser 106 as a vulnerable security point of credential provisioning. The registration flow reduces dependence on the web browser for the provisioning of the authenticator device. Instead of a web browser 106, the authenticator 302 includes a dedicated credentialing application 330 that executes in the authenticator 302. The credentialing application 330 of the authenticator 302 communicates directly with the authentication server 304 to automatically provision a FIDO credential that can be used to authenticate users to any FIDO protected application-either to access FIDO protected resources within the authenticator 302 (internal authenticator) or a resource external to the authenticator 302 (e.g., an external authenticator such as a PC). Using the credentialing application 330 removes the web browser 106 from the FIDO registration, thereby reducing attacks that seek to exploit any vulnerability of the web browser 106.

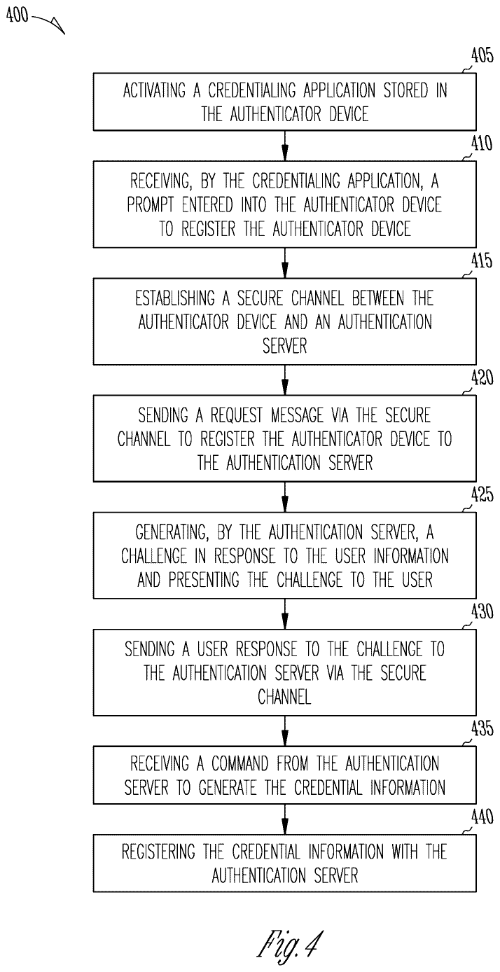

FIG. 4 is a flow diagram of an example of a method 400 of provisioning a FIDO credential using a credentialing application 330 of an authenticator device, such as authenticator 302 in FIG. 3. The authenticator device may be a platform device, mobile device, etc. At block 405, the credentialing application 330 is activated in the authenticator 302 (e.g., by the user). When activated, the credentialing application 330 may present a registration menu or window to the user on a user interface with prompts for the user to follow to register the authenticator device. At block 410, the credentialing application 330 receives a prompt (e.g., entered by the user) to register the authenticator device.

At block 415, the credentialing application 330 establishes a secure channel 332 between the authenticator 302 and the authentication server 304. The secure channel can be a global platform secure channel, Seos secure channel, a European Telecommunications Standard Institute (ETSI) secure channel, or a Public Key Infrastructure (PKI) based secure channel. At block 420, a request message to register the authenticator device (or otherwise provision credentialing information for the device) is sent to the authentication server 304 via the secure channel 332. The request message can include user information 110 needed for the registration. A web browser is not used in this exchange of the request message and user information 110 between the authenticator 302 and the authentication server 304.

At block 425, a challenge 324 is generated by the authentication server 304 in response to the communication from the authenticator 302. In the example of FIG. 3, the challenge is sent and received by the authenticator 302 over the secure channel 332. In some examples, the challenge 324 is sent by the authentication server 304 via a web browser 106. The challenge 324 may be presented to the user using the authenticator, or the challenge 324 may be presented on a separate device using the web browser. The challenge 324 may be for information previously configured when the user created an account, such as a PIN, biometric 114, or password. In another example, the challenge 324 is a Quick Response (QR) code presented on a separate device (e.g., a platform device of the user) using the web browser. The camera of the authenticator 302 is used to read the QR code.

At block 430, a user response to the challenge 324 is sent by the authenticator 302 to the authentication server 304. The response to the challenge 324 is sent over the secure channel 332. The response may be the PIN or biometric 114, or the response may the QR code depending on the type of challenge 324.

If the challenge 324 is passed, at block 435 the authentication server 304 sends a command that is received by the authenticator 302 over the secure channel 332. The command causes the authenticator 302 to generate credential information, e.g., a credential ID 316 and a FIDO key pair. In some examples, the FIDO key pair includes a FIDO public key 318 and a FIDO private key 320. At block 440, the credential information is registered with the authentication server 304. Registering of the credential information can include returning the credential ID 316 and the FIDO public key 318 to the authentication server 304 via the secure channel 332. The private key 120 is retained by the authenticator 302, and the private key 320 can be a signature key used for generating a digital signature 322 by the authenticator 302. When the authenticator 302 wishes to authenticate to the server 304, the authenticator 302 returns a response to a challenge from the authentication server 304 that is signed using the digital signature 322 to show that the authenticator 302 holds the FIDO credential. The signed response to the challenge may be sent using the credentialing application 330 and the secure channel 332 or using a web browser.

The systems, devices, and methods described herein provide improve security in the provisioning of credential information to authenticator devices by reducing dependence on a web browser for communicating with the authenticator devices. Instead, authenticator devices are automatically provisioned an additional FIDO credential via a dedicated credentialing application operating in the authenticator devices. The dependence on the web browser is bypassed by a secure channel established between the credentialing application and the authentication server. The FIDO credential can then be used to authenticate users to any FIDO protected application.

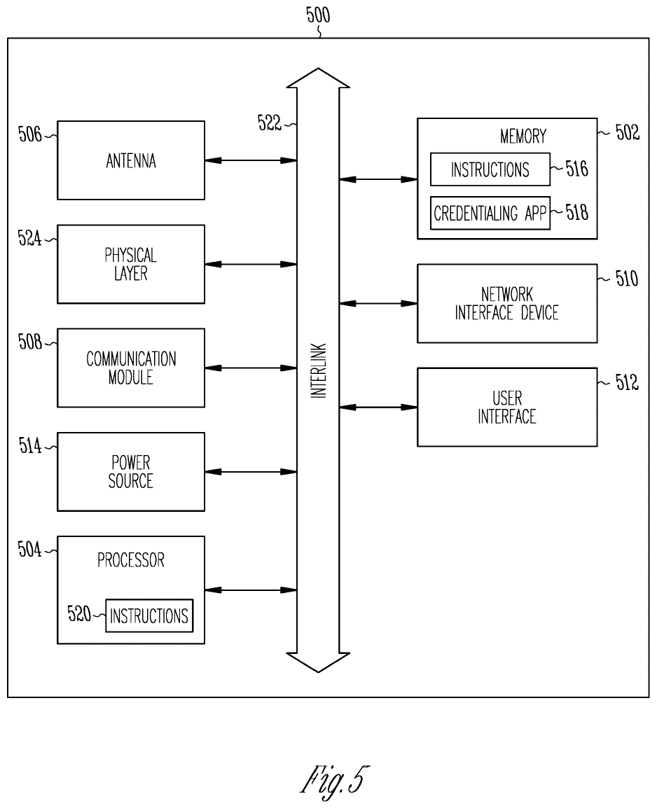

FIG. 5 is a block diagram schematic of various example components of a device 500 for supporting the device architectures described and illustrated herein. The device 500 is an authenticator device and could be, for example, a platform device, mobile device, (or other initiator device) that presents credential information of authority, status, rights, and/or entitlement to privileges for the holder of the device 500.

With reference specifically to FIG. 5, additional examples of a device 500 for supporting the device architecture described and illustrated herein may generally include one or more of a memory 502, processing circuitry such as processor 504, one or more antennas 506, a communication port or communication module 508, a network interface device 510, a user interface 512, and a power source 514 or power supply.

Memory 502 can be used in connection with the execution of application programming or instructions by processing circuitry, and for the temporary or long-term storage of program instructions or instruction sets 516 and/or authorization data, such as credential data, or access control data or instructions, as well as any data, data structures, and/or computer-executable instructions needed or desired to support the above-described device architecture. For example, memory 502 can contain executable instructions 516 that are used by a processor 504 of the processing circuitry to run other components of device 500, to perform operations of a credentialing application 518, to calculate encryption keys to communicate credential data, and/or to perform any of the functions or operations described herein, such as the method of FIG. 5 for example. Memory 502 can comprise a computer readable medium that can be any medium that can contain, store, communicate, or transport data, program code, or instructions for use by or in connection with device 500. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), any solid-state storage device, in general, a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

The processing circuitry of the device 500 is configured (e.g., by firmware) to perform the functions of authenticator devices described herein, such as the functions of the method of FIG. 4 for example. The processing circuitry can correspond to one or more computer processing devices or resources. For instance, processor 504 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 504 can be provided as a microprocessor, Central Processing Unit (CPU), or plurality of microprocessors or CPUs that are configured to execute instructions sets stored in an internal memory 520 and/or memory 502.

Antenna 506 can correspond to one or multiple antennas and can be configured to provide for wireless communications between device 500 and another device. Antenna(s) 506 can be operatively coupled to physical layer circuitry comprising one or more physical (PHY) layers 524 to operate using one or more wireless communication protocols and operating frequencies including, but not limited to, the IEEE 802.15.1, Bluetooth®, Bluetooth® Low Energy (BLE), near field communications (NFC), ZigBee, GSM, CDMA, Wi-Fi, RF, UWB, and the like. In an example, antenna 506 may include one or more antennas coupled to one or more physical layers 524 to operate using ultra-wide band (UWB) for in band activity/communication and Bluetooth (e.g., BLE) for out-of-band (OOB) activity/communication. However, any RFID or personal area network (PAN) technologies, such as the IEEE 502.15.1, near field communications (NFC), ZigBee, GSM, CDMA, Wi-Fi, etc., may alternatively or additionally be used for the OOB activity/communication described herein.

Device 500 may additionally include a communication module 508 and/or network interface device 510. Communication module 508 can be configured to communicate according to any suitable communications protocol with one or more different systems or devices either remote or local to device 500. Network interface device 510 includes hardware to facilitate communications with other devices over a communication network utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi, IEEE 802.16 family of standards known as WiMax), IEEE 802.15.4 family of standards, and peer-to-peer (P2P) networks, among others. In some examples, network interface device 510 can include an Ethernet port or other physical jack, a Wi-Fi card, a Network Interface Card (NIC), a cellular interface (e.g., antenna, filters, and associated circuitry), or the like. In some examples, network interface device 510 can include a plurality of antennas to wirelessly communicate using at least one of single-input multiple-output (SIMO), multiple-input multiple-output (MIMO), or multiple-input single-output (MISO) techniques. In some example embodiments, one or more of the antenna 506, communication module 508, and/or network interface device 510 or subcomponents thereof, may be integrated as a single module or device, function or operate as if they were a single module or device, or may comprise of elements that are shared between them.

User interface 512 can include one or more input devices and/or display devices. Examples of suitable user input devices that can be included in user interface 512 include, without limitation, one or more buttons, a keyboard, a mouse, a touch-sensitive surface, a stylus, a camera, a microphone, etc. Examples of suitable user output devices that can be included in user interface 512 include, without limitation, one or more LEDs, an LCD panel, a display screen, a touchscreen, one or more lights, a speaker, etc. It should be appreciated that user interface 512 can also include a combined user input and user output device, such as a touch-sensitive display or the like.

Power source 514 can be any suitable internal power source, such as a battery, capacitive power source or similar type of charge-storage device, etc., and/or can include one or more power conversion circuits suitable to convert external power into suitable power (e.g., conversion of externally-supplied AC power into DC power) for components of the device 500.

Device 500 can also include one or more interlinks or buses 522 operable to transmit communications between the various hardware components of the device. A system bus 522 can be any of several types of commercially available bus structures or bus architectures.

### ADDITIONAL DISCLOSURE AND EXAMPLES

Example 1 includes subject matter (such as of provisioning credential information) comprising activating a credentialing application stored in an authenticator device; receiving, by the credentialing application, a prompt entered into the authenticator device to register the authenticator device to access an online service; establishing a secure channel between the authenticator device and an authentication server; sending a request message to register the authenticator device to the authentication server via the secure channel, wherein the request message includes user information; generating a challenge by the authentication server in response to the request message and presenting the challenge to the user; sending a response to the challenge from the authenticator device to the authentication server via the secure channel; receiving a command from the authentication server to generate credential information for the online service, the credential information including a key pair; and registering a first key of the key pair with the authentication server.

In Example 2, the subject matter of Example 1 optionally includes the authentication server presenting the challenge using a web browser.

In Example 3, the subject matter of Example 2 optionally includes the authentication server presenting a QR code using the web browser.

In Example 4, the subject matter of Example 1 optionally includes the authentication server sending the challenge to the authenticator device via the secure channel.

In Example 5, the subject matter of one or any combination of Examples 1-4 optionally includes sending a digital signature generated by the authenticator device using a second signature key of the key pair stored in the authenticator device

In Example 6, the subject matter of one or any combination of Examples 1-5 optionally includes accessing the online service associated with the credential information; receiving a challenge from the authentication server via a web browser; and sending a signed challenge response to the authentication server via the secure channel using the credentialing application.

In Example 7, the subject matter of one or any combination of Examples 1-6 optionally includes accessing the online service associated with the credential information using a web browser; receiving a challenge from the authentication server via the web browser; and sending a signed challenge to the authentication server using the web browser.

In Example 8, the subject matter of one or any combination of Examples 1-7 optionally includes establishing a secure channel between the authenticator device and the authentication server using a secure channel.

In Example 9, the subject matter of one or any combination of Examples 1-8 optionally includes credential information being Fast Identity Online (FIDO) credential information, and the key pair of the credential information being a FIDO key pair.

Example 10 include subject matter (such as an authentication server) or can optionally be combined with one or any combination of Examples 1-9 to include such subject matter, comprising processing circuitry including at least one hardware processor, and a memory. The memory stores instructions that cause the at least one hardware processor to perform operations comprising establish a secure channel with a credentialing application of a separate authenticator device; receive a request message to register the authenticator device via the secure channel; send a challenge to the credentialing application in response to receiving the user information; receive a response to the challenge from credentialing application via the secure channel; send a command to the credentialing application to generate credential information, the credential information including a key pair; receive a key of the key pair from the credentialing application; and register the key of the key pair.

In Example 11, the subject matter of Example 10 optionally includes the memory including instructions that cause the at least one hardware processor to perform operations including sending the challenge via the secure channel.

In Example 12, the subject matter of Example 10 optionally includes the memory including instructions that cause the at least one hardware processor to perform operations including sending the challenge via a web browser.

In Example 13, the subject matter of Example 12 optionally includes the memory including instructions that cause the at least one hardware processor to perform operations including sending the challenge as a Quick Response (QR) code to the web browser for presenting on a web page.

In Example 14, the subject matter of one or both of Examples 12 and 13 optionally includes the memory including instructions that cause the at least one hardware processor to perform operations including receiving a request message from the credentialing application to access an online service associated with the credential information; encoding a challenge to send to the credentialing application via the web browser in response to the request message; and decoding a signed challenge received from the credentialing application via the secure channel.

In Example 15, the subject matter of one or both of Examples 12 and 13 optionally includes the memory including instructions that cause the at least one hardware processor to perform operations including decoding a request message from the credentialing application to access an online service associated with the credential information; encoding a challenge to send to the credentialing application via the web browser in response to the request message; and decoding a signed challenge received from the credentialing application via the web browser.

In Example 16, the subject matter of one or any combination of Examples 12-15 optionally includes the memory including instructions that cause the at least one hardware processor to perform operations including decoding a digital signature with the response to the challenge, wherein the digital signature is generated by the credentialing application using a second signature key of the key pair.

In Example 17, the subject matter of one or any combination of Examples 12-16 optionally includes the memory including instructions that cause the at least one hardware processor to perform operations including communicating information with the credentialing application of the separate device according to a global platform secure channel protocol, wherein the separate device is a mobile phone.

In Example 18, the subject matter of one or any combination of Examples 10-17 optionally includes the memory including instructions that cause the at least one hardware processor to perform operations including sending a command to the credentialing application to generate Fast Identity Online (FIDO) credential information; and registering a FIDO key received from the credentialing application in response to the command.

Example 19 includes subject matter (or can optionally be combined with one or any combination of Examples 1-18 to include such subject matter) such as a computer readable storage medium including instructions that when executed by at least one processor of a user device, causes the user device to perform operations comprising receiving, via a user interface of the mobile device, a prompt to register the mobile device with an online service; sending a request message to register the authenticator device to the authentication server via the secure channel, wherein the request message includes user information; receiving a challenge from the authentication server in response to the user information; sending a response to the challenge to the authentication server via the secure channel; receiving a command from the authentication server to generate the credential information including a credential identifier (ID) and a key pair; and registering a first key of the key pair with the authentication server.

In Example 20, the subject matter of example 19 optionally includes instructions that cause the mobile device to perform acts including receiving the challenge from the authenticator device via the secure channel.

In Example 21, the subject matter of one or both of Examples 19 and 20 optionally includes instructions that cause the mobile device to perform acts including decoding a QR code to receive the challenge.

In Example 22, the subject matter of Example 21 optionally includes instructions that cause the mobile device to perform acts including generating a digital signature using a private key of the key pair; and including the digital signature in the response to the challenge.

In Example 23, the subject matter of one or any combination of Examples 19-22 optionally includes instructions that cause the mobile device to perform acts including receiving the challenge from the authentication server via the web browser; and sending a signed challenge response to the authentication server via the secure channel.

In Example 24, the subject matter of one or any combination of Examples 19-23 optionally includes instructions that cause the mobile device to perform acts including encoding a request message to access an online service associated with the credential information; decoding a challenge from the authentication server via the web browser; and sending a signed challenge to the authentication server using the web browser.

In Example 25, the subject matter of one or any combination of Examples 19-23 optionally includes instructions that cause the mobile device to perform acts including communicating information with the authentication server according to a global platform secure channel protocol.

These non-limiting Examples can be combined in any permutation or combination. The above detailed description includes references to the accompanying drawings, which form a part of the detailed description. The drawings show, by way of illustration, specific embodiments in which the invention can be practiced. The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, the subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

1. A computing device implemented method of provisioning credential information, the method comprising:
activating a credentialing application stored in an authenticator device;
receiving, by the credentialing application, a prompt entered into the authenticator device to register the authenticator device to access an online service;
establishing a secure channel between the authenticator device and an authentication server;
sending a request message to register the authenticator device to the authentication server via the secure channel, wherein the request message includes user information;
generating a challenge by the authentication server in response to the request message and presenting the challenge to the user;
sending a response to the challenge from the authenticator device to the authentication server via the secure channel;
receiving a command from the authentication server to generate credential information for the online service, the credential information including a key pair; and
registering a first key of the key pair with the authentication server.

2. The method of claim 1, wherein the generating the challenge from the authentication server includes the authentication server presenting the challenge using a web browser.

3. The method of claim 2, wherein the authentication server presenting the challenge includes the authentication server presenting a QR code using the web browser.

4. The method of claim 1, wherein the authentication server presenting the challenge includes the authentication server sending the challenge to the authenticator device via the secure channel.

5. The method of claim 1, wherein sending the response to the challenge includes sending a digital signature generated by the authenticator device using a second signature key of the key pair stored in the authenticator device.

6. The method of claim 1, including:
accessing the online service associated with the credential information;
receiving a challenge from the authentication server via a web browser; and
sending a signed challenge response to the authentication server via the secure channel using the credentialing application.

7. The method of claim 1, including:
accessing the online service associated with the credential information using a web browser;
receiving a challenge from the authentication server via the web browser; and
sending a signed challenge to the authentication server using the web browser.

8. The method of claim 1, wherein establishing a secure channel includes establishing a secure channel between the authenticator device and the authentication server using a secure channel.

9. The method of claim 1, wherein the credential information is Fast Identity Online (FIDO) credential information, and the key pair of the credential information is a FIDO key pair.

10. An authentication server comprising:
processing circuitry including at least one hardware processor; and
a memory storing instructions that cause the at least one hardware processor to perform operations comprising:
establish a secure channel with a credentialing application of a separate authenticator device;
receive a request message to register the authenticator device via the secure channel;
send a challenge to the credentialing application in response to receiving the user information;
receive a response to the challenge from credentialing application via the secure channel;
send a command to the credentialing application to generate credential information, the credential information including a key pair;
receive a key of the key pair from the credentialing application; and
register the key of the key pair.

11. The authentication server of claim 10, wherein the instructions further cause the at least one hardware processor to perform operations including sending the challenge via the secure channel.

12. The authentication server of claim 10, wherein the instructions further cause the at least one hardware processor to perform operations including sending the challenge via a web browser.

13. The authentication server of claim 12, wherein the instructions further cause the at least one hardware processor to perform operations including sending the challenge as a Quick Response (QR) code to the web browser for presenting on a web page.

14. The authentication server of claim 12, wherein the instructions further cause the at least one hardware processor to perform operations including:
receiving a request message from the credentialing application to access an online service associated with the credential information;
encoding a challenge to send to the credentialing application via the web browser in response to the request message; and
decoding a signed challenge received from the credentialing application via the secure channel.

15. The authentication server of claim 12, wherein the instructions further cause the at least one hardware processor to perform operations including:
decoding a request message from the credentialing application to access an online service associated with the credential information;
encoding a challenge to send to the credentialing application via the web browser in response to the request message; and
decoding a signed challenge received from the credentialing application via the web browser.

16. The authentication server of claim 12, wherein the instructions further cause the at least one hardware processor to perform operations including decoding a digital signature with the response to the challenge, wherein the digital signature is generated by the credentialing application using a second signature key of the key pair.

17. The authentication server of claim 12, wherein the instructions further cause the at least one hardware processor to perform operations including communicating information with the credentialing application of the separate device according to a global platform secure channel protocol, wherein the separate device is a mobile phone.

18. The authentication server of claim 10, wherein the instructions further cause the at least one hardware processor to perform operations including:
sending a command to the credentialing application to generate Fast Identity Online (FIDO) credential information; and
registering a FIDO key received from the credentialing application in response to the command.

19. A computer readable storage medium including instructions that, when performed using processing circuitry of a mobile device, cause the mobile device to perform acts comprising:
receiving, via a user interface of the mobile device, a prompt to register the mobile device with an online service;
establishing a secure channel with an authentication server;
sending a request message to register the authenticator device to the authentication server via the secure channel, wherein the request message includes user information;
receiving a challenge from the authentication server in response to the user information;
sending a response to the challenge to the authentication server via the secure channel;
receiving a command from the authentication server to generate the credential information including a credential identifier (ID) and a key pair; and
registering a first key of the key pair with the authentication server.

20. The computer readable storage medium of claim 19, including instructions that cause the mobile device to perform acts including receiving the challenge from the authenticator device via the secure channel.

21. The computer readable storage medium of claim 19, including instructions that cause the mobile device to perform acts including decoding a QR code to receive the challenge.

22. The computer readable storage medium of claim 21, including instructions that cause the mobile device to perform acts including:
generating a digital signature using a private key of the key pair; and
including the digital signature in the response to the challenge.

23. The computer readable storage medium of claim 19, including instructions that cause the mobile device to perform acts including:
receiving the challenge from the authentication server via the web browser; and
sending a signed challenge response to the authentication server via the secure channel.

24. The computer readable storage medium of claim 19, including instructions that cause the mobile device to perform acts including:
encoding a request message to access an online service associated with the credential information;
decoding a challenge from the authentication server via the web browser; and
sending a signed challenge to the authentication server using the web browser.

25. The computer readable storage medium of claim 19, including instructions that cause the mobile device to perform acts including communicating information with the authentication server according to a global platform secure channel protocol.
